(19) United States
(12) Patent Application Publication
(10) Pub. No.: US 2026/0370287 A1
(43) Pub. Date: Nov. 19, 2026

(54) WIRELESS COMMUNICATION DEVICE, WIRELESS COMMUNICATION SYSTEM, WIRELESS COMMUNICATION METHOD, AND WIRELESS COMMUNICATION PROGRAM

(71) Applicant: NTT, Inc., Tokyo (JP)

(72) Inventors: Kotaro NAGANO, Musashino-shi, Tokyo (JP); Hirantha ABEYSEKERA, Musashino-shi, Tokyo (JP); Yusuke ASAI, Musashino-shi, Tokyo (JP); Yasushi TAKATORI, Musashino-shi, Tokyo (JP)

(73) Assignee: NTT, Inc., Tokyo (JP)

(21) Appl. No.: 19/142,974

(22) PCT Filed: Jan. 11, 2023
(86) PCT No.: PCT/JP2023/000474

§ 371 Date: Jun. 25, 2025

(51) Int. Cl. H04B 7/06; H04W 24/10; H04W 84/12

(52) U.S. Cl. CPC H04B 7/0626; H04W 24/10; H04W 84/12

(57) ABSTRACT

The wireless communication device performs wireless communication with other devices, and includes a plurality of interfaces, a correlation DB, and a CSI estimation unit. The plurality of interfaces includes a CSI measurement interface and a data transmission interface. The correlation DB is configured to hold CSI correlation between a CSI measurement link managed by the CSI measurement interface and a data transmission link managed by the data transmission interface. The CSI estimator is configured to perform measuring CSI of the CSI measurement link, acquiring the CSI correlation from the correlation DB, and estimating CSI of the data transmission link on the basis of the CSI correlation and the CSI obtained by measuring. The data transmission interface is configured to perform wireless communication with the other devices on the basis of the CSI obtained by the estimating.

### TECHNICAL FIELD

The present disclosure relates to a wireless communication device, a wireless communication system, a wireless communication method, and a wireless communication program.

### BACKGROUND ART

A multiple-input multiple-output (MIMO) technique of performing spatial multiplex transmission with a plurality of antennas is known as a method for increasing the communication capacity. With the advancement of the MIMO technique and the widening of the bandwidth, there is an increasing demand for acquisition of high-frequency channel state information (CSI).

1.5 round-trip packet exchanges are required to acquire CSI. In particular, in a case where a time-varying channel in which a channel environment changes over time is used, there is a problem that accurate information transmission cannot be performed as a difference in environment increases between when CSI is acquired and when actual data transmission is performed.

In order to solve the above-described problem, Non Patent Literature 1 discloses a technique of improving communication performance of MIMO eigenmode transmission in a time-varying channel by performing channel prediction on a transmission side and a reception side. Non Patent Literature 2 discloses a technique of improving communication performance of MIMO eigenmode transmission in a time-varying channel by simulation using a time-varying channel model.

### CITATION LIST

### Non Patent Literature

Non Patent Literature 1: Dohi and one other person, “Solution with Channel Prediction by Transmitting and Receiving Side of Communication Performance Decrement of Multiple-Input Multiple-Output Eigenbeam Space Division Multiplexing in Time-Varying Channel”, The transactions of the Institute of Electronics, Information, and Communication Engineers. B, Jul. 1, 2016, Vol. J99-B, No.10, p.938-965
Non Patent Literature 2: Dohi and one other person, “Solution without Channel Prediction of Communication Performance Decrement by Feedback Delay of Multiple-Input Multiple-Output Eigenbeam Space Division Multiplexing in Time-Varying Channel”, The transactions of the Institute of Electronics, Information, and Communication Engineers. B, Jul. 1, 2016, Vol. J 99-B, No. 2, p. 60-77

### SUMMARY OF INVENTION

### Technical Problem

However, in a system using a multi-link device (MLD) having a plurality of links, CSI estimation according to the number of links is required. Therefore, the overhead associated with the CSI estimation further increases. That is, there is a problem that accurate information transmission cannot be performed as a difference in environment further increases between when CSI is acquired and when actual data transmission is performed.

In order to solve the above-described problem, a first object of the present disclosure is to provide a wireless communication device in which the overhead associated with CSI estimation is reduced, and a timing of CSI acquisition and a timing of actual data transmission are adjusted to be close to or overlap each other, so that the influence of a channel varying with time can be reduced, and accurate information transmission can be performed.

### Solution to Problem

A first aspect of the present disclosure is preferably a wireless communication device that performs wireless communication with other devices, including: a plurality of interfaces; a correlation DB; and a CSI estimation unit, in which the plurality of interfaces includes a CSI measurement interface and a data transmission interface, the correlation DB is configured to hold CSI correlation between a CSI measurement link managed by the CSI measurement interface and a data transmission link managed by the data transmission interface, the CSI estimation unit is configured to perform CSI measurement processing for measuring CSI of the CSI measurement link, processing for acquiring the CSI correlation from the correlation DB, and CSI estimation processing for estimating CSI of the data transmission link on the basis of the CSI correlation and the CSI obtained by the CSI measurement processing, and the data transmission interface is configured to perform wireless communication with the other devices on the basis of the CSI obtained by the CSI estimation processing.

A second aspect of the present disclosure is preferably a wireless communication system that performs wireless communication between a wireless communication device and other devices, in which links managed by the wireless communication device include a CSI measurement link and a data transmission link, and the wireless communication system is configured to perform processing for measuring CSI of the CSI measurement link, processing for acquiring CSI correlation between the CSI measurement link and the data transmission link, processing for estimating CSI of the data transmission link on the basis of the CSI correlation and the CSI obtained by the CSI measurement, and processing for performing wireless communication using the data transmission link on the basis of the CSI obtained by the CSI estimation.

A third aspect of the present disclosure is preferably a wireless communication method for performing wireless communication between a wireless communication device and other devices, in which links managed by the wireless communication device include a CSI measurement link and a data transmission link, and the wireless communication method is configured to measure CSI of the CSI measurement link, acquire CSI correlation between the CSI measurement link and the data transmission link, estimate CSI of the data transmission link on the basis of the CSI correlation and the CSI obtained by the CSI measurement, and perform wireless communication using the data transmission link on the basis of the CSI obtained by the CSI estimation.

A fourth aspect of the present disclosure is preferably a wireless communication program that is implemented by a wireless communication device that performs wireless communication with other devices, in which links managed by the wireless communication device include a CSI measurement link and a data transmission link, and the wireless communication program includes a program that causes a computer to perform processing for measuring CSI of the CSI measurement link, processing for acquiring CSI correlation between the CSI measurement link and the data transmission link, processing for estimating CSI of the data transmission link on the basis of the CSI correlation and the CSI obtained by the CSI measurement, and processing for performing wireless communication using the data transmission link on the basis of the CSI obtained by the CSI estimation.

### Advantageous Effects of Invention

According to the first to fourth aspects of the present disclosure, the overhead associated with CSI estimation is reduced, and a timing of CSI acquisition and a timing of actual data transmission are adjusted to be close to or overlap each other, so that the influence of a channel varying with time can be reduced, and accurate information transmission can be performed.

### BRIEF DESCRIPTION OF DRAWINGS

FIG. 1 is a diagram illustrating a wireless communication system according to a first embodiment of the present disclosure.

FIG. 2 is a flowchart illustrating correlation calculation processing according to the first embodiment of the present disclosure.

FIG. 3 is a flowchart illustrating CSI estimation processing according to the first embodiment of the present disclosure.

FIG. 4 is a diagram illustrating a wireless communication system according to a modification example of the first embodiment of the present disclosure.

FIG. 5 is a functional block diagram showing the wireless communication system according to the modification example of the first embodiment of the present disclosure.

FIG. 6 is a functional block diagram showing an interface according to the modification example of the first embodiment of the present disclosure.

FIG. 7 is a diagram illustrating a hardware configuration of a CSI estimation unit according to the modification example of the first embodiment of the present disclosure.

### DESCRIPTION OF EMBODIMENTS

### First Embodiment

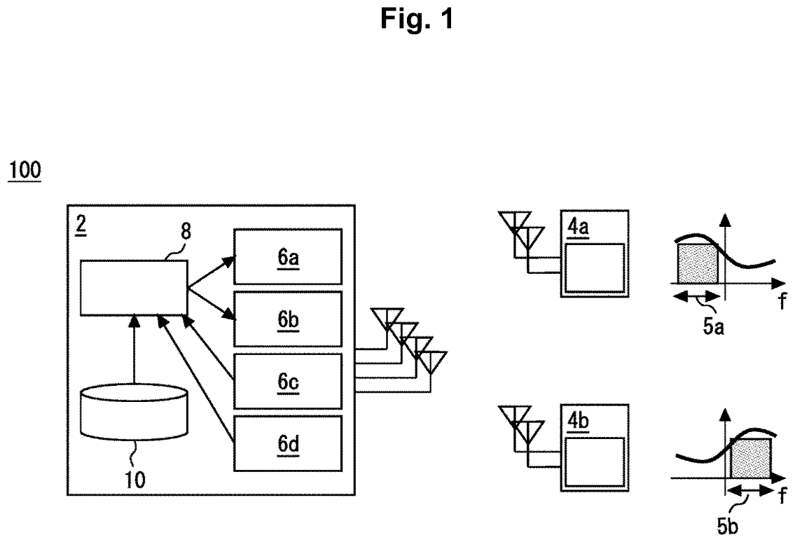

FIG. 1 is a diagram illustrating a wireless communication system according to a first embodiment of the present disclosure. A wireless communication system 100 achieves the object of the present disclosure by estimating CSI of data transmission links on the basis of CSI of links that are not used for data transmission.

Wireless communication in the wireless communication system 100 will be described. First, acquisition of CSI correlation performed in advance will be described.

The wireless communication system 100 includes an MLD 2. The MLD 2 performs wireless communication with devices 4a and 4b as communication partners. Here, a multi-user MIMO environment using an MLD having a plurality of interfaces is assumed. In addition, each interface manages a different frequency channel.

The MLD 2 includes one or more interfaces. Here, an aspect in which interfaces 6a, 6b, 6c, and 6d are provided is shown. Among the four interfaces, the links managed by the interfaces 6a and 6b are data transmission links. In particular, the frequency band of the link managed by the interface 6b is the same as those of the devices 4a and 4b. The links managed by the interfaces 6c and 6d are assumed as CSI measurement links.

First, the interface handling each link performs CSI measurement. The data measured by each interface is transmitted to a CSI estimation unit 8.

Subsequently, CSI correlation between the data transmission link and the CSI measurement link is acquired. The acquisition of the CSI correlation is performed by the CSI estimation unit 8. In the present disclosure, an environment is assumed in which the phase of the CSI in each link cannot be estimated due to large environmental variations. That is, the CSI estimated here is the channel amplitude for each subcarrier in each link. The acquired CSI correlation is stored in a correlation DB 10.

Next, CSI estimation for the data transmission link will be described. The interface handling the CSI measurement link performs CSI measurement constantly. In a case where the CSI varies, the variation information is transmitted to the CSI estimation unit 8. The CSI estimation unit 8 estimates CSI of the data transmission link on the basis of the variation information and the information of the correlation DB 10.

On the basis of the estimated CSI, the CSI estimation unit 8 determines a resource unit to be used for wireless communication with the devices 4a and 4b so that the channel amplitude is maximized. The resource unit may be one carrier of the OFDM signal, or a unit in which a plurality of carriers are collected. The determined information is transmitted to the interface handling the data transmission link. Here, it is transmitted to the interface 6b handling the link of the same frequency band as the devices 4a and 4b.

The interface 6b performs wireless communication with the devices 4a and 4b by using the resource unit determined by the CSI estimation unit 8. For example, in a case where the channel amplitude in the device 4a is indicated by the graph on the right side of the device 4a, the subcarrier band of the assigned resource unit is a band 5a. Similarly, in a case where the channel amplitude in the device 4b is indicated by the graph on the right side of the device 4b, the subcarrier band of the assigned resource unit is a band 5b.

In the present disclosure, as described above, CSI estimation is performed using a surplus link that is not a data transmission link. Therefore, the CSI estimation for the data transmission link can be performed without performing packet exchange that has been required for conventional CSI estimation. Therefore, the overhead associated with the CSI estimation is reduced, and a timing of the CSI acquisition and a timing of the actual data transmission are adjusted to be close to or overlap each other, so that the influence of the channel varying with time can be reduced, and accurate information transmission can be performed.

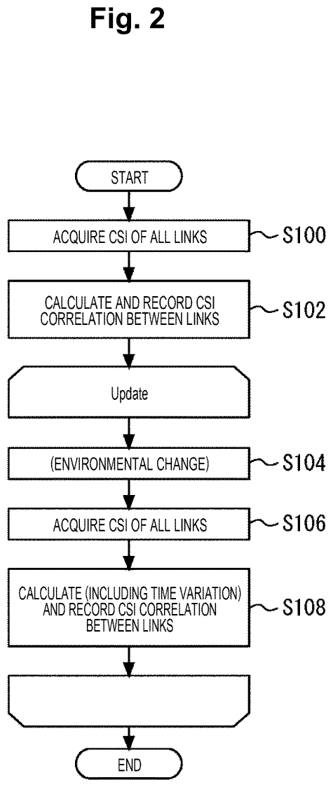

FIG. 2 is a flowchart illustrating correlation calculation processing according to the first embodiment of the present disclosure. First, CSI of all links is obtained in Step 100.

Next, CSI correlation between the links is calculated and recorded in Step 102. This processing is performed by the CSI estimation unit 8, for example. The CSI estimation unit 8 calculates the CSI correlation between the links, and records the calculation results in the correlation DB 10. The CSI correlation is, for example, a difference or the like. The processing up to this point is the correlation calculation processing performed in advance for CSI estimation.

Subsequent Steps 104 to 108 represent correlation calculation processing that is repeatedly performed as an update every time an environmental change occurs. First, the occurrence of an environmental change is confirmed in Step 104. The environmental change may occur naturally or may be actively generated by changing a transmission power or the like

Next, CSI of all links is obtained in Step 106. Subsequently, CSI correlation between the links is calculated and recorded in Step 108. This processing is performed by the CSI estimation unit 8, for example. The calculation of the CSI correlation includes a variation with time. That is, in addition to the CSI correlation between the links, a CSI variation of each link is recorded. Therefore, the correlation in the time-varying direction of how the CSI of each link changes is also calculated. The CSI estimation unit 8 records the calculation results in the correlation DB 10.

As described above, in addition to the correlation calculation processing performed in advance, processing for repeating the update in response to the environmental change is performed. Accordingly, CSI estimation according to the environment can be performed.

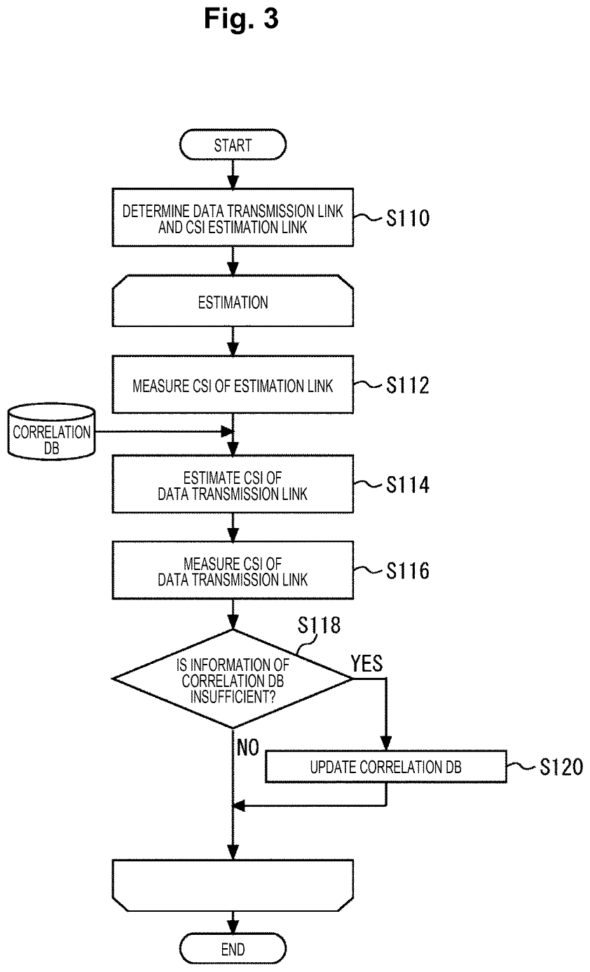

FIG. 3 is a flowchart illustrating CSI estimation processing according to the first embodiment of the present disclosure. First, a data transmission link and a CSI estimation link are determined in Step 110. The determination is performed by the CSI estimation unit, for example.

Subsequent Steps 112 to 120 represent CSI estimation processing to be repeatedly performed. First, CSI of the estimation link is measured in Step 112. Regarding this estimation link, CSI measurement is performed appropriately or constantly.

Next, CSI of the data transmission link is estimated in Step 114. This processing is performed by the CSI estimation unit 8, for example. In addition, the estimation is performed on the basis of the correlation calculation results of the links stored in the correlation DB 10. Next, the CSI of the data transmission link is measured in Step 116.

In Step 118, it is confirmed whether the information of the correlation DB is insufficient. First, the CSI measured in Step 116 is compared with the CSI estimated in Step 114, and an error is acquired as error information. Then, it is determined whether the information of the correlation DB is insufficient on the basis of the error information. For example, in a case where the value of the error information is larger than a certain value, it is determined that the information of the correlation DB is insufficient. That is, in a case where the CSI measured in Step 116 and the CSI estimated in Step 114 deviate from each other, it is determined that the information of the correlation DB is insufficient. In a case where the information of the correlation DB is insufficient, the processing proceeds to Step 120. If not, the CSI estimation processing ends.

Next, the correlation DB is updated in Step 120. That is, the error information acquired in Step 118 is stored in the correlation DB 10 to update the correlation calculation results in the correlation DB 10.

In a case where a SN ratio of the CSI of the data transmission link is small, the CSI may be separately stored as low-reliability information. Furthermore, in this case, adjustment may be performed such as shortening the interval for performing Step 118.

In the present disclosure, as described above, CSI estimation is performed using a surplus link that is not a data transmission link. Therefore, the CSI estimation for the data transmission link can be performed without performing packet exchange that has been required for conventional CSI estimation. That is, the overhead associated with the CSI estimation is reduced, and a timing of the CSI acquisition and a timing of the actual data transmission are adjusted to be close to or overlap each other, so that the influence of the channel varying with time can be reduced, and accurate information transmission can be performed.

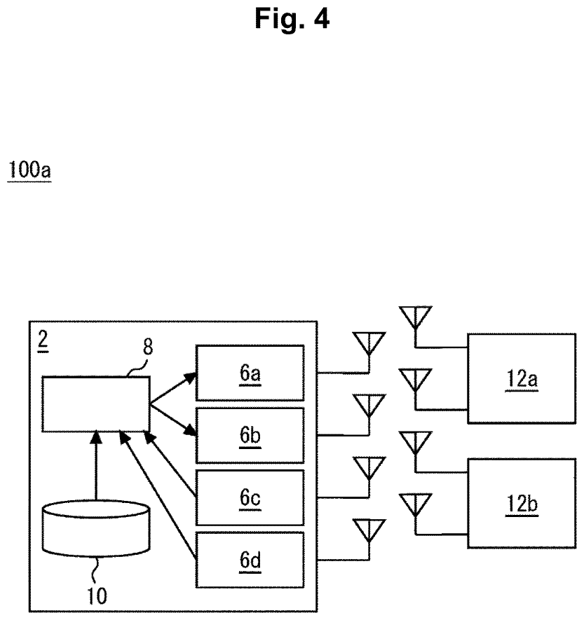

FIG. 4 is a diagram illustrating a wireless communication system according to a modification example of the first embodiment of the present disclosure. A wireless communication system 100a is different from the wireless communication system 100 in that communication partners of the MLD 2 are MLDs 12a and 12b having a plurality of interfaces.

The wireless communication system 100a includes the MLDs 12a and 12b. Like the MLD 2, the MLDs 12a and 12b have a plurality of interfaces. That is, in CSI correlation calculation processing, it is necessary to acquire the correlation corresponding to each interface of each terminal.

Therefore, it is determined in advance which interface each interface of the MLD 2 will correspond to. For example, it is determined in advance that an interface 6b corresponds to an interface of the MLD 12a and an interface 6d corresponds to an interface of the MLD 12b. The correlation calculation processing and the CSI estimation processing described above are performed for each corresponding interface.

Accordingly, even in a case where the communication partner is the MLD, CSI estimation can be performed using a surplus link that is not a data transmission link. That is, as in the first embodiment, the overhead associated with the CSI estimation is reduced, and a timing of the CSI acquisition and a timing of the actual data transmission are adjusted to be close to or overlap each other, so that the influence of the channel varying with time can be reduced, and accurate information transmission can be performed.

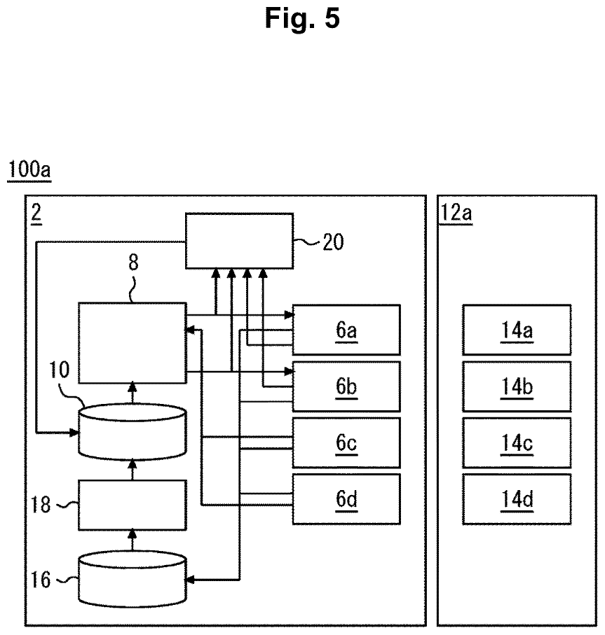

FIG. 5 is a functional block diagram showing the wireless communication system according to the modification example of the first embodiment of the present disclosure. Here, wireless communication performed between the MLD 2 and the MLD 12a in the wireless communication system 100a will be described. In addition, here, the interfaces 6a and 6b of the MLD 2 are data transmission links, and the interfaces 6c and 6d are CSI measurement links. Interfaces 14a and 14b of the MLD 12a are data transmission links, and interfaces 14c and 14d are CSI measurement links. Note that one or more data transmission links and one or more CSI measurement links may be provided, and the present invention is not limited to this example.

The processing flow in the functional block diagram of FIG. 5 will be described. First, CSI measurement is performed in the interfaces 6a to 6d and the interfaces 14a to 14d. The measured data is transmitted to a CSI DB 16.

The CSI DB 16 holds the transmitted CSI data between the links. The CSI DB 16 may hold SN ratio data during the measurement in order to adjust a re-measurement interval when the correlation calculation processing is re-performed.

The CSI DB 16 transmits the transmitted CSI data between the links to a correlation calculation unit 18. The correlation calculation unit 18 outputs CSI correlation information of the links when the CSI data between the links for each time is input thereto. Examples of the CSI correlation information include CSI correlation at each time and correlation of variations between the links for each time.

The CSI correlation information output from the correlation calculation unit 18 is transmitted to a correlation DB 10. The correlation DB 10 holds the CSI correlation information. The correlation DB 10 may hold correction information based on the actual link measurement described for the processing in Steps 116 to 120.

The CSI correlation information held in the correlation DB 10 is transmitted to a CSI estimation unit 8. The CSI estimation unit 8 outputs CSI estimation data of the data transmission link when the CSI information of the CSI measurement link and the received CSI correlation information are input thereto.

The CSI estimation data output from the CSI estimation unit 8 is transmitted to the interfaces 6a and 6b handling the data transmission links. The interfaces 6a and 6b perform wireless communication with the interfaces 14a and 14b on the basis of the CSI estimation data.

The MLD 2 may include a correction information calculation unit 20. The correction information calculation unit 20 has a function of performing the processing described in Steps 116 to 120. That is, the correction information calculation unit 20 has a function of performing correction processing for the correlation DB based on the CSI measurement in the data transmission link.

The flow of the correction processing described above in the functional block diagram of FIG. 5 will be described. The correction information calculation unit 20 receives the CSI estimation data output from the CSI estimation unit 8 and the CSI measurement data output from the interfaces 6a and 6b handling the data transmission links, together. The received pieces of data are compared to acquire error information.

Subsequently, the correction information calculation unit 20 transmits the acquired error information to the correlation DB 10. The correlation DB can update the correlation calculation results in the correlation DB 10 by storing the error information.

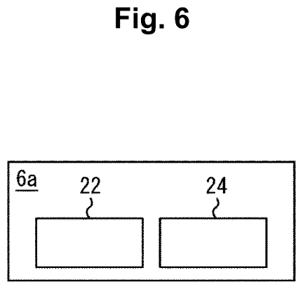

FIG. 6 is a functional block diagram showing the interface according to the modification example of the first embodiment of the present disclosure. The interface 6a has a CSI measurement unit 22. The CSI measurement unit 22 performs CSI measurement. The interface 6a includes a CSI notification unit 24. The CSI notification unit notifies the CSI DB 16 of the CSI data measured by the CSI measurement unit.

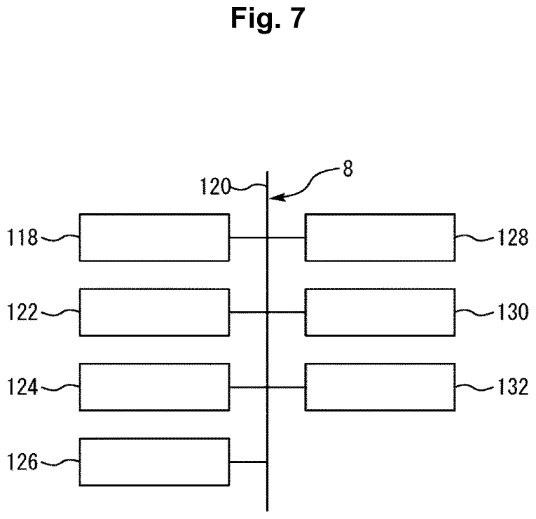

FIG. 7 is a diagram illustrating a hardware configuration of the CSI estimation unit according to the modification example of the first embodiment of the present disclosure. The CSI estimation unit 8 includes a CPU 118. The CPU 118 is connected to a bus line 120. Memory devices such as a ROM 122, a RAM 124, and a storage 126 are connected to the bus line 120. The memory device stores a wireless communication program to be executed by the CPU 118. The CSI estimation unit 8 can realize a unique function according to the present embodiment when the CPU 118 executes the wireless communication program.

A communication interface 128 is also connected to the bus line 120. The CSI estimation unit 8 realizes communication with a network via the communication interface 128. An operation unit 130 and a display unit 132 are further connected to the bus line 120. The operation unit 130 and the display unit 132 function as a user interface for handling the CSI estimation unit 8.

As described above, the CSI estimation unit 8 can realize a unique function according to the present embodiment when the CPU 118 executes the wireless communication program. That is, the CSI estimation unit 8 can also be realized by a computer and the program. In addition, the program can be provided by being recorded in a recording medium or through a network.

### REFERENCE SIGNS LIST

4a Device
4b Device
6a Interface
6b Interface
6c Interface
6d Interface
8 CSI estimation unit
10 Correlation DB
14a Interface
14b Interface
14c Interface
14d Interface
20 Correction information calculation unit
100 Wireless communication system
100a Wireless communication system

1. A wireless communication device that performs wireless communication with other devices, the wireless communication device comprising:
a plurality of interfaces; a correlation DB; and a CSI estimator,
wherein the plurality of interfaces includes
a CSI measurement interface and a data transmission interface,
the correlation DB is configured to
hold CSI correlation between a CSI measurement link managed by the CSI measurement interface and a data transmission link managed by the data transmission interface,
the CSI estimator is configured to perform
measuring CSI of the CSI measurement link,
acquiring the CSI correlation from the correlation DB, and
estimating CSI of the data transmission link on the basis of the CSI correlation and the CSI obtained by the measuring, and
the data transmission interface is configured to perform wireless communication with the other devices on the basis of the CSI obtained by the measuring.

2. The wireless communication device according to claim 1,
wherein the interface is configured to perform processing for acquiring CSI of a link managed by the interface and for transmitting the acquired CSI to the CSI estimator, and
the CSI estimator is configured to perform
calculating CSI correlation for a combination of the links, and
recording the CSI correlation in the correlation DB.

3. The wireless communication device according to claim 2,
wherein the calculating includes causing the interface to re-acquire CSI of the link managed by the interface and to transmit the re-acquired CSI to a CSI estimator when an environmental change occurs, and
causing the CSI estimator to re-calculate the CSI correlation for the combination of the links, and
the re-calculated CSI correlation includes correlation in a time-varying direction.

4. The wireless communication device according to claim 1, further comprising:
a correction information calculator,
wherein the correction information calculator is configured to perform
measuring CSI of the data transmission link,
acquiring error information between the measured CSI of the data transmission link and the CSI obtained by the estimating, and
storing the error information in the correlation DB and for updating a correlation calculation result in the correlation DB.

5. The wireless communication device according to claim 2,
wherein the CSI measurement interface and the data transmission interface are determined on the basis of a result of the calculating.

6. A wireless communication system that performs wireless communication between a wireless communication device and other devices,
wherein links managed by the wireless communication device include a CSI measurement link and a data transmission link, and
the wireless communication system is configured to perform
measuring CSI of the CSI measurement link,
acquiring CSI correlation between the CSI measurement link and the data transmission link,
estimating CSI of the data transmission link on the basis of the CSI correlation and the CSI obtained by the CSI measurement, and
performing wireless communication using the data transmission link on the basis of the CSI obtained by the estimating.

7. A wireless communication method for performing wireless communication between a wireless communication device and other devices,
wherein links managed by the wireless communication device include a CSI measurement link and a data transmission link, and
the wireless communication method is configured to
measure CSI of the CSI measurement link,
acquire CSI correlation between the CSI measurement link and the data transmission link,
estimate CSI of the data transmission link on the basis of the CSI correlation and the CSI obtained by the CSI measurement, and
perform wireless communication using the data transmission link on the basis of the CSI obtained by the CSI estimation.

8. A non-transitory storage medium storing a computer readable wireless communication program configured to cause a computer to execute the wireless communication device according to claim 1.
